(19) United States
(12) Patent Application Publication
(10) Pub. No.: US 2016/0068770 A1
(43) Pub. Date: Mar. 10, 2016

(54) APPARATUSES, SYSTEMS, STAGING HOPPERS, AND METHODS FOR CONTROLLING CONTINUOUS FEED OF FEEDSTOCK TO A GASIFIER

(71) Applicant: AG ENERGY SOLUTIONS, INC., SPOKANE, WA (US)

(72) Inventors: PHILIP W. APPEL, CHENEY, WA (US); THOMAS D. WEIR, PULLMAN, WA (US); DANIEL A. HOWARD, CHENEY, WA (US)

(21) Appl. No.: 14/846,146

(22) Filed: Sep. 4, 2015

Related U.S. Application Data
(60) Provisional application No. 62/046,085, filed on Sep. 4, 2014.

(51) Int. Cl. C10J 3/50; B65G 65/02; C10J 3/72; C10J 3/48; C10J 3/46

(52) U.S. Cl. CPC C10J 3/50; C10J 3/48; C10J 3/46; C10J 3/723; B65G 65/02; C10J 2200/15; C10J 2300/0916; C10J 2300/0956; C10J 2300/1643

(57) ABSTRACT

Apparatuses, systems, staging hoppers, and methods for controlling continuous feed of feedstock into a gasifier are described. An example method staging feedstock in a staging hopper of a gasification system, and activating a stirrer to provide the feedstock to from the staging hopper to a gasifier of the gasification system. The gasifier is configured to gasify the feedstock to produce syngas.

### CROSS REFERENCE TO RELATED APPLICATIONS

We hereby claim benefit under Title 35, United States Code, Section 119(e) of U.S. provisional patent application Ser. No. 62/046,085, filed Sep. 4, 2014. The 62/046,085 application is hereby incorporated by reference into this application.

### BACKGROUND OF THE INVENTION

The process of producing energy using gasification has been in use since the 1800s. However, little advancement in the technology has been realized over the years because of the availability and widespread adoption of fossil fuels. The gasification process often uses feedstock that is bulky and difficult to feed (or cannot be fed) directly into a gasifier. Therefore, processing (e.g. chopping, shredding, etc.) of the biomass feedstock is typically required. Further, systems may be utilized for providing processed biomass feedstock to the gasifier, but these systems may have difficulty in managing a consistent feed into the gasifier, resulting in inconsistent syngas production.

### SUMMARY

Example systems are disclosed herein. An example system may include a staging hopper connected to a hopper. The staging hopper may include a stirrer configured to continuously supply biomass feedstock to an outlet. The example system may further include a gasifier configured to receive the biomass feedstock from the outlet of the staging hopper and to gasify the biomass feedstock to provide the syngas from a syngas outlet.

Example staging hoppers are disclosed herein. An example staging hopper may include a side wall forming an enclosure, and a top portion comprising a biomass feedstock inlet configured to receive biomass feedstock. The example staging hopper may further include a floor extending perpendicular to the side wall near a bottom edge of the side wall. The example staging hopper may further include a shaft extending up through the floor, and sweep members affixed to the shaft above the floor that are configured to sweep the biomass feedstock toward an outlet as the shaft rotates.

Example methods are disclosed herein. An example method may include staging feedstock in a staging hopper of a gasification system, and activating a stirrer to provide the feedstock from the staging hopper to a gasifier of the gasification system. The gasifier may be configured to gasify the feedstock to produce syngas.

It is to be understood that the examples of the invention are not limited by the details of construction or to the arrangements of the components set forth in the following description of examples or illustrated in the drawings. The invention is capable of other embodiments and of being practiced and carried out in various ways. In addition, it is to be understood that the phraseology and terminology employed herein are for the purpose of the description and should not be regarded as limiting.

### BRIEF DESCRIPTION OF THE DRAWINGS

Various other examples, features, and attendant advantages of examples of the present invention will become fully appreciated as the same becomes better understood when considered in conjunction with the accompanying drawings, wherein:

FIG. 1 is a block diagram of an exemplary portion of a gasification system including a staging hopper according to an embodiment of the invention.

FIG. 2 is perspective view of an exemplary staging hopper according to an embodiment of the invention.

FIG. 3 is a cross-sectional perspective view of the staging hopper according to an embodiment of the invention.

FIG. 4 is perspective view of an exemplary staging hopper according to an embodiment of the invention.

FIG. 5 is a flow chart of an exemplary method for continuously providing biomass feedstock to a gasifier of a gasification system according to an embodiment of the invention.

FIG. 6 is a flow chart of an exemplary method for maintaining a biomass feedstock level in a staging hopper of a gasification system according to an embodiment of the invention.

FIG. 7 is a block diagram of a gasification system according to an embodiment of the invention.

### DETAILED DESCRIPTION

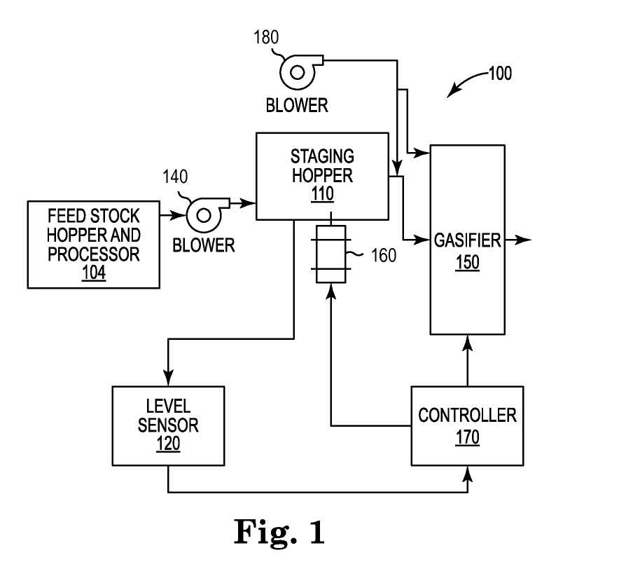

Examples of the present invention are generally directed to a staging hopper for use in a biomass gasification system. Many of the specific details of certain embodiments of the invention are presented in the following description and in FIGS. 1-7, to provide a thorough understanding of such embodiments. One skilled in the art will understand, however, that other embodiments may be practiced, and that some embodiments may be practiced without several of the details described in the following description.

FIG. 1 is a block diagram of a portion of a gasification system 100 including a staging hopper 110 according to an embodiment of the invention. Staging hopper 110 may be coupled to a feedstock hopper and processor 104 that may chop and/or shred waste biomass and feed the processed biomass into staging hopper 110. Staging hopper 110 may collect incoming processed biomass and stage it (e.g. store it) before providing the biomass into a gasifier 150. Staging hopper 110 may be connected to and/or include a level sensor 120, a controller 170, and an electric motor 160. Blower 140 may convey processed biomass to staging hopper 110 from feedstock hopper and processor 104. The portion of gasification system 100 may further include a blower 180 to provide combustion air to gasifier 150 of which a portion may be used to facilitate movement of the processed biomass into gasifier 150. Accordingly, a portion of combustion air from blower 180 may be bypassed into a transfer line to help in avoiding a situation where the processed biomass becomes jammed or stuffed during transfer of processed biomass from staging hopper 110 to gasifier 150. The bypass air also prevents hot gasses from gasifier 150 from flowing down the feed auger to staging hopper 110. Staging hopper 110, gasifier 160, and system 100 may have additional and/or rearranged components than those shown in FIG. 1.

Level sensor 120 may determine a level of processed biomass held within staging hopper 110. Controller 170 may receive level sensor information from level sensor 120 and may control operational aspects of gasification system 100 in accordance with the level of processed biomass held within staging hopper 110. Level sensor 120 may be a paddle-type sensor (e.g., a sensor that detects a level based on rotation/non-rotation of the paddle, or another sensor capable of indicating a level of processed biomass held within staging hopper 110) or a capacitance-type sensor that detects a level using capacitive coupling. Electric motor 160 may, for example, receive a signal from controller 170 causing electric motor 160 to rotate or otherwise move a stirrer inside staging hopper 110.

In operation, feedstock hopper and processor 104 may receive waste biomass (e.g., from a shredder), and may process the waste biomass to produce feedstock for gasifier 150 by chopping and/or shredding waste biomass. Blower 140 may provide the processed biomass feedstock from feedstock hopper and processor 104 to staging hopper 110. In other examples, an auger may be used to transfer the processed biomass feedstock from feedstock hopper and processor 104 to staging hopper 110. In some embodiments, the transfer of the processed biomass feedstock from feedstock hopper and processor 104 to staging hopper 110 may be controlled by controller 170 based on a level of the processed feedstock in staging hopper 110. For example, when a level of the processed feedstock in staging hopper 110 falls below a threshold level (e.g. threshold height), controller 170 may activate blower 140 to transfer the processed biomass from feedstock hopper and processor 104 to staging hopper 110.

Electric motor 160 may rotate a shaft in staging hopper 110, which sweeps processed biomass feedstock into an opening of a tube connecting staging hopper 110 to gasifier 150. The rotation of the shaft of staging hopper 110 may be in cycles of fixed speed and fixed duration. The transfer of the biomass feedstock from staging hopper 110 to gasifier 150 may be assisted by injecting pressurized air from blower 180 into the transfer tube to reduce and/or prevent clogging and compaction of the processed biomass feedstock. Gasifier 150 may gasify the processed biomass feedstock to provide syngas as an output.

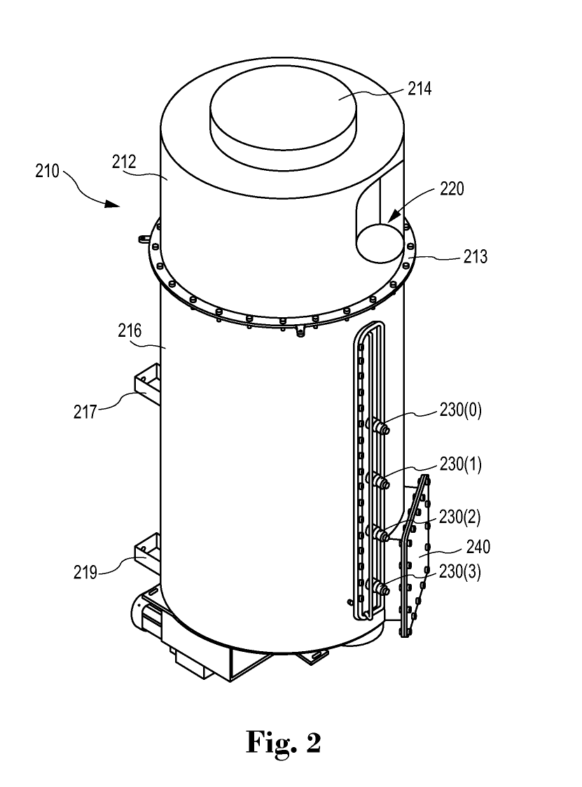

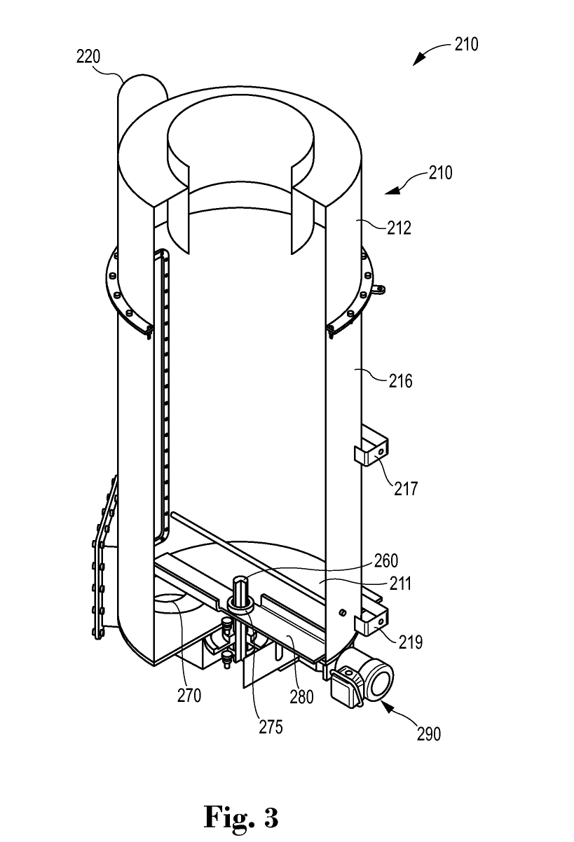

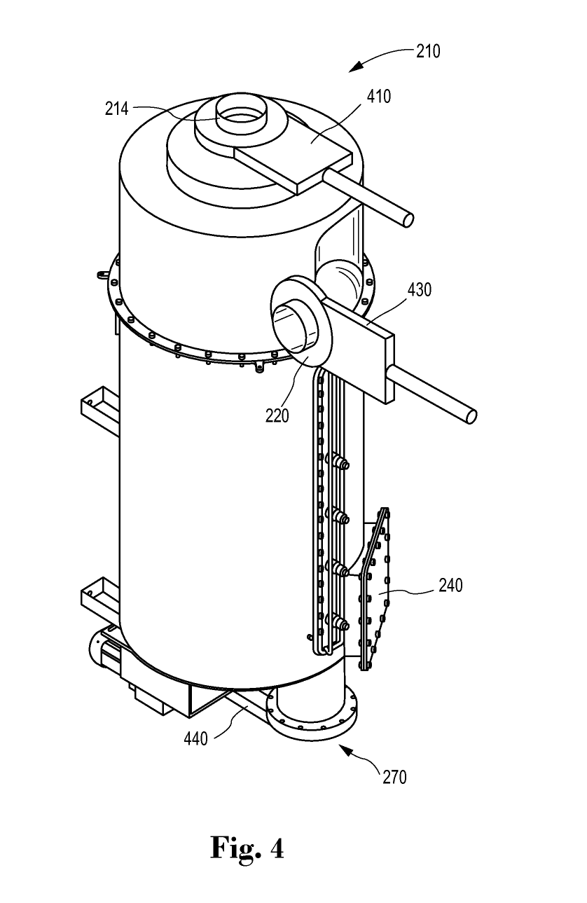

The rotation of electric motor 160 may be controlled by controller 170 such that a consistent flow of the processed biomass feedstock is provided to gasifier 150. The rate or speed at which electric motor 160 turns the shaft in staging hopper 110 is suited to the particular type of biomass being gasified. For example, for straw, the rotation in staging hopper 110 is approximately 13 rpm, but the rate can be adjusted in the instant configuration between 8.5 and 19.5 rpm to accommodate other biomass types. In some examples, staging hopper 110 may also include a configurable outlet orifice (e.g., is adjustable or replaceable to alter outlet opening sizes) to help achieve consistent biomass flow to gasifier 150. The size of the outlet orifice may be based on a biomass type, moisture level, density, and/or how finely or coarsely the biomass has been shredded. The rotation cycle frequency of electric motor 160 may be based on conditions in gasifier 150, e.g., a level of feedstock, a temperature profile, etc. A consistent flow of feedstock to gasifier 150 may improve consistency and quality of the syngas generated by gasifier 150. Gasifier 150 may include a stirrer (e.g., a shaft with affixed horizontal stir rods that agitate the processed biomass when the shaft is rotated) that assists in the gasification process. Controller 170 may monitor a temperature of gasifier 150 and/or level of processed biomass feedstock within the combustion chamber of gasifier 150, and may direct electric motor 160 to begin rotating to enable a feed from staging hopper 110 to gasifier 150 to maintain a desired temperature and/or feedstock level within gasifier 150. In some embodiments, controller 170 may additionally or instead control the stir rate of the stirrer of gasifier 150 to maintain a desired temperature profile within and gas production from gasifier 150. For example, if the temperature profile of gasifier 150 falls below a temperature threshold, controller 170 may decrease the stir rate of the stirrer in gasifier 150. Further, if the temperature profile of gasifier 150 rises above a temperature threshold, controller 170 may increase the stir rate of the stirrer in gasifier 150. Normally, the unburnt feedstock at the top of gasifier 150 insulates gasifier 150 from the flame, and thus the temperature at the top is quite a bit less than the temperature at the bottom or other points within the fire tube. Thus, a temperature at the top of gasifier 150 that is above a certain threshold (e.g., 250 degrees Celsius) may cause controller 170 to increase the stir cycle frequency. This, in turn, may trigger (due to a low level being sensed in gasifier 150) staging hopper 110 and/or a feed auger to provide more feedstock from staging hopper 110 to gasifier 150. If the temperature continues to rise at the top of gasifier 150 above a higher threshold (e.g., 300 degrees Celsius), controller 170 may determine that staging hopper 110 is not sufficiently providing feedstock to gasifier 150, and may shut down combustion air to gasifier 150 from blower 180 and close valves that allow the escape of gasses to prevent further combustion within gasifier 150 until the condition is cleared. Thus, the temperature at the top of gasifier 150 may be used to determine whether there is a malfunction in staging hopper 110 and/or a malfunction in the transfer of the feedstock from staging hopper 110 to gasifier 150. FIGS. 2-4 depict various views of an exemplary staging hopper according to an embodiment of the invention. FIG. 2 is a perspective view of staging hopper 210 according to an embodiment of the invention. FIG. 3 shows a schematic cross-sectional perspective view of staging hopper 210 as shown from another perspective according to an embodiment of the invention. FIG. 4 shows a schematic isometric view of staging hopper 210 according to an embodiment of the invention. FIGS. 2-4 include common elements, which are referenced using the same reference numbers.

Staging hopper 210 may include a cylindrical container with a side wall 216, an access port 240, a top portion 212, and a floor 211. Side wall 216 may include mounting provisions for one or more level sensors 230(0-3) mounted in a vertical array alongside wall 216 of staging hopper 210. While mounting provisions for four of level sensors 230(0-3) are depicted, fewer or more than four level sensor mounting provisions may be provided. Staging hopper 210 may include one or more mounting brackets 217 and 219 that may allow staging hopper 210 to be secured and stabilized wherever it is installed and/or to allow additional system elements to be mounted thereto. Side wall 216 may also incorporate an access port 240 to allow access to the interior of staging hopper 210 for routine maintenance, repair, and/or cleaning.

Top portion 212 may be coupled to side wall 216 using a bolted flange 213 or other mechanism for fastening top portion 212 to side wall 216. Top portion 212 may include at least two openings within it: a blower return 214 and a processed biomass inlet 220. Blower return 214 may allow air that is used to convey processed biomass to staging hopper 210 to escape from staging hopper 210 rather than building up excess pressure within staging hopper 210. Blower return 214 may further include a screen or other mechanism to prevent escape of processed biomass. Processed biomass inlet 220 may receive processed biomass feedstock from a feedstock hopper and processor, such as feedstock hopper and processor 104 of FIG. 1 and direct it tangentially into staging hopper 210 to induce cyclonic separation of the air and feedstock.

Floor 211 may include a processed biomass outlet 270 that allows processed biomass feedstock to be transferred to a gasifier, such as gasifier 150 of FIG. 1, and an opening 275 through which the stirrer is coupled to staging hopper 210. The stirrer may include shaft 260 that extends several inches up through a bearing housed within the center of floor 211. The bearing may allow shaft 260 to rotate freely within floor 211 and seal opening 275 to prevent and/or reduce the escape of processed biomass feedstock and back pressure from gasifier 150. Sweep member 280 may attach to shaft 260 at a small clearance above floor 211 on one end of shaft 260. At the other end of shaft 260 an electric motor 290 is attached. Preferably, the clearance between floor 211 and sweep member 280 is maintained at 3 (three) times the effective diameter of the largest feedstock particulates, though the height may be greater or lower depending upon the feedstock type (e.g. straw, wood chips, etc.). When shaft 260 is rotated, for example using electric motor 290, sweep member 280 may agitate the processed biomass feedstock within staging hopper 210 and direct a portion of the processed biomass feedstock to processed biomass outlet 270 to be conveyed to the gasifier. Shaft 260 may be operated in stir cycles such that shaft 260 is rotated at a constant speed for a fixed duration. In some examples, the rotation speed of shaft 260 may be changed by control signals provided to electric motor 290 from a controller, such as controller 170 of FIG. 1. The rotation speed of shaft 260 may be based on a type of feedstock. The stir cycle frequency of shaft 260, and thus the rate of feed of processed biomass feedstock to the gasifier, can be adapted based on signals from level sensors 230(0-4) mounted on side wall 216, signals related to syngas production from the gasifier, signals from a level sensor in a gasifier such as gasifier 150, and/or atmospheric conditions.

Staging hopper 210 may further include valves at each of openings 214, 220, and 270 to serve as airlocks, which may allow the gasifier attached to staging hopper 210 to operate below or above atmospheric pressure. In some examples, valves 410, 430, and 440 may be knife gate valves. For example, staging hopper 210 may include an inlet knife gate valve 430 at processed biomass inlet 220, an outlet knife gate valve 440 at processed biomass outlet 270, and blower return knife gate valve 410 at blower return 214. The airlock provided by knife gate valves 410, 430, and 440 may prevent and/or reduce unwanted flow of gas and air from or to the gasifier through staging hopper 210 particularly during times when staging hopper 210 is being filled.

In operation, staging hopper 210 may be filled by closing outlet knife gate valve 440 and opening inlet knife gate valve 430 and blower return knife gate valve 410. The processed biomass may then be blown or conveyed using any conventional means through biomass inlet 220 and into a chamber surrounded by side wall 216 of staging hopper 210 (e.g., using blower 140 of FIG. 1). Once the highest level sensor 230(0) indicates staging hopper 210 is full (e.g., at or above a high level threshold), inlet knife gate valve 430 and blower return knife gate valve 410 may be closed (e.g. using signals provided by a controller such as controller 170 of FIG. 1). Outlet knife gate 440 may then be opened and provision of the processed biomass from staging hopper 210 into the gasifier may resume by rotating sweep member 280 attached to shaft 260 using electric motor 290. Responsive to the lowest level sensor 230(3) indicating staging hopper 210 is empty or low (e.g., at or below a low level threshold), the sequence of opening and closing knife gate valves 410, 430, and 440 may be repeated to refill staging hopper 210. Knife gate valves 410, 430, and 440 and/or electric motor 290 may be controlled by a control system (e.g., controller 170 of FIG. 1) that monitors level sensors 230(0-3) and monitors conditions of the gasifier. Implementing knife gate valves 410, 430, and 440 in staging hopper 210, rather than in the gasifier, to maintain pressure in the gasifier may improve reliability of knife gate valves 410, 430, and 440 by moving them away from the heat of the gasifier. Further, implementing airlocks on top of the gasifier may disadvantageously increase the overall system height of an already large gasifier. Additionally, the volume of staging hopper 210 may be considered the airlock volume, which may reduce a number of cycles of knife gate valves 410, 430, and 440 that are required to provide additional feedstock as compared with knife gate valves 410, 430, and 440 being implemented in the gasifier.

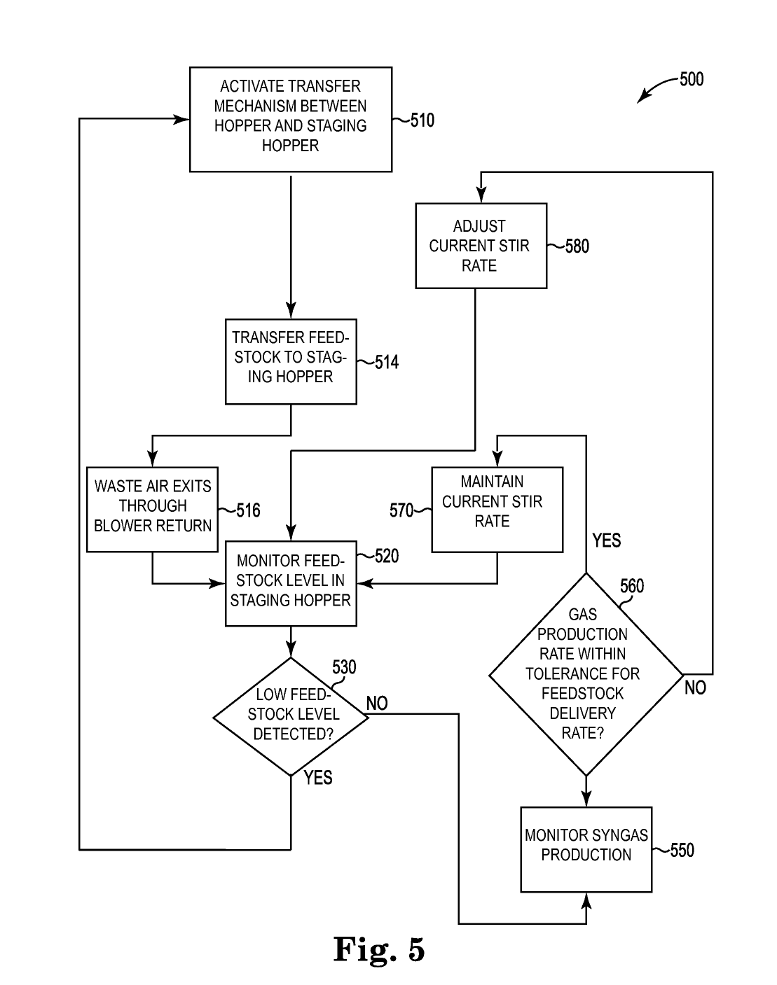

FIG. 5 is a flowchart for a method 500 for continuously providing biomass feedstock to a gasifier of a gasification system according to an embodiment of the invention. Method 500 illustrated by the flowchart may be implemented using a combination of components described in FIGS. 1-4.

Method 500 may include activating a feedstock transfer mechanism to transfer feedstock from a hopper to a staging hopper, at 510. The feedstock transfer mechanism may be implemented using blower 140 of FIG. 1. The hopper may be implemented using feedstock hopper and processor 104 of FIG. 1. The staging hopper may be implemented using staging hopper 110 of FIG. 1 and/or staging hopper 210 of FIGS. 2-4. In some embodiments, prior to activating the feedstock transfer mechanism, method 500 may include adjusting airlock valves. The airlock valves may be implemented using knife gate valves 410, 430, and 440 of FIG. 4. For example, outlet knife gate valve 440 may be closed and knife gate valves 410 and 430 may be opened at block 510.

Method 500 may further include transferring the feedstock to the staging hopper, at 514. Method 500 may further include allowing waste air to exit through the blower return of the staging hopper, at 516, such as through blower return 214 of FIGS. 2 and 4. Method 500 may further include monitoring a level (e.g. height or volume) of the feedstock in the staging hopper, at 520, and disengaging the feedstock transfer mechanism when the level exceeds a high threshold. In some embodiments, after disengaging the feedstock transfer mechanism, method 500 may include adjusting airlock valves. Monitoring of the feedstock level may be performed by a controller, such as controller 170 of FIG. 1, and monitoring may include reading levels of one or more level sensors, such as level sensor 120 of FIG. 1 and/or level sensors 230(0-3) of FIG. 2. The feedstock level may be an amount of feedstock currently being held in the staging hopper (e.g., height within the staging hopper). The one or more level sensors may be paddle-type sensors.

Method 500 may further include determining whether a low feedstock level (e.g., below a low threshold) is detected, at 530. The low feedstock level may be a point at which the staging hopper is sufficiently empty such that it needs to be refilled to ensure a continuous feed to the gasifier. Waiting until the staging hopper is completely empty may result in a gap of flow of feedstock to the gasifier. Responsive to detection of a low feedstock level, method 500 may further include reactivating the feedstock transfer mechanism to transfer feedstock from the hopper to the staging hopper, at 510. Responsive to a determination that the level in the staging hopper is not low, method 500 may further include monitoring the syngas production, at 550. The syngas production may be monitored by the controller based on energy production (e.g., power output from a generator operating based on combustion of produced syngas).

Method 500 may further include determining whether the syngas production is within a tolerance for the feedstock delivery rate, at 560. If the syngas production is within the tolerance, method 500 may further include maintaining a stir rate of the gasifier, at 570 and looping back to monitor the feedstock level in the staging hopper, at 520. If the syngas production is outside the tolerance, method 500 may further include adjusting the stir rate of the gasifier, at 580, and looping back to monitor the feedstock level in the staging hopper, at 520. For example, the stir rate may be increased to increase syngas production and may be decreased to decrease syngas production.

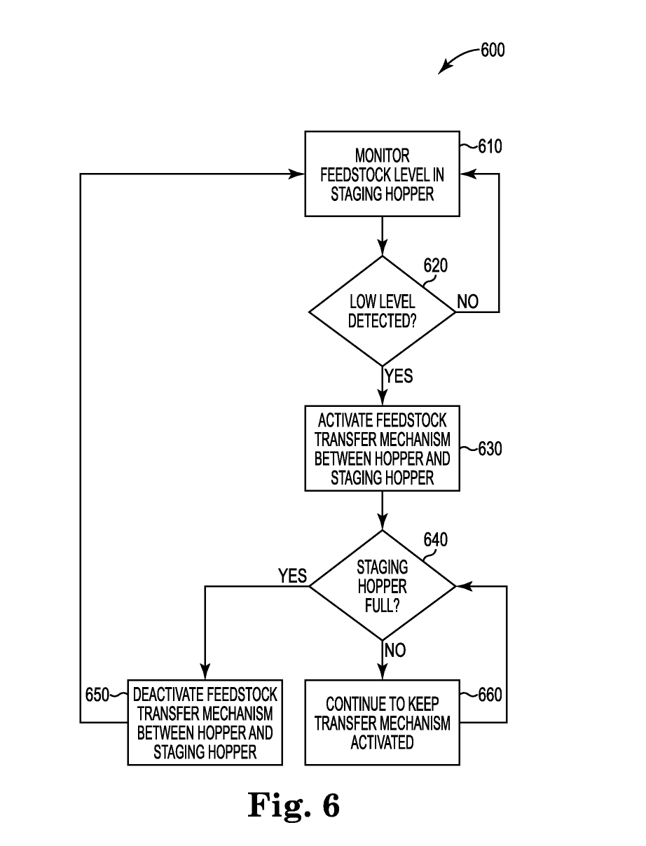

FIG. 6 is a flowchart for an exemplary method 600 for maintaining a biomass feedstock level in a staging hopper of a gasification system according to an embodiment of the invention. Method 600 illustrated by the flowchart may be implemented, for example, using a combination of components described in FIGS. 1-4.

Method 600 may include monitoring a feedstock level in the staging hopper, at 610. The staging hopper may be implemented using staging hopper 110 of FIG. 1 and/or staging hopper 210 of FIGS. 2-4. The feedstock level may be monitored by a controller, such as controller 170 of FIG. 1, which may monitor one or more level sensors attached to the staging hopper, such as level sensor 120 of FIG. 1 and/or one or more of level sensors 230(0-3) of FIG. 2. Method 600 may further include determining whether the feedstock level is low (e.g., below a low threshold), at 620. Determining whether the feedstock level is low may be based on data received from the level sensor(s). If the feedstock level is not low, method 600 may further include continuing to monitor the feedstock level of the staging hopper.

Responsive to determining that the feedstock level is low, method 600 may further include activating a feedstock transfer mechanism between a hopper and a staging hopper, at 630. The hopper may be implemented using feedstock hopper and processor 104 of FIG. 1. The feedstock transfer mechanism may be implemented using blower 140 of FIG. 1. Responsive to determining that the feedstock level is low, method 600 may further include activating airlocks to maintain pressure in the gasifier prior to activating the transfer mechanism.

Method 600 may further include determining whether the staging hopper is full (e.g., above a high threshold), at 640. Determining whether the staging hopper is full may be based on signals from one or more level sensors. Responsive to determining that the staging hopper is not full, method 600 may include activating and/or continuing to keep the feedstock transfer mechanism active. Responsive to determining that the staging hopper is full, method 600 may further include deactivating the feedstock transfer mechanism, at 650.

Methods 500 and 600 depicted in FIGS. 5 and 6, respectively, may be implemented using a field-programmable gate array (FPGA) device, an application-specific integrated circuit (ASIC), a processing unit such as a central processing unit (CPU), a digital signal processor (DSP), a controller, another hardware device, a firmware device, or any combination thereof. As an example, methods 500 and 600 may be implemented by a computing system using, for example, one or more processing units that may execute instructions for performing the method that may be encoded on a computer readable medium. The processing units may be implemented using, e.g. processors or other circuitry capable of processing (e.g. one or more controllers or other circuitry). The computer readable medium may be transitory or non-transitory and may be implemented, for example, using any suitable electronic memory, including but not limited to, system memory, flash memory, solid state drives, hard disk drives, etc.

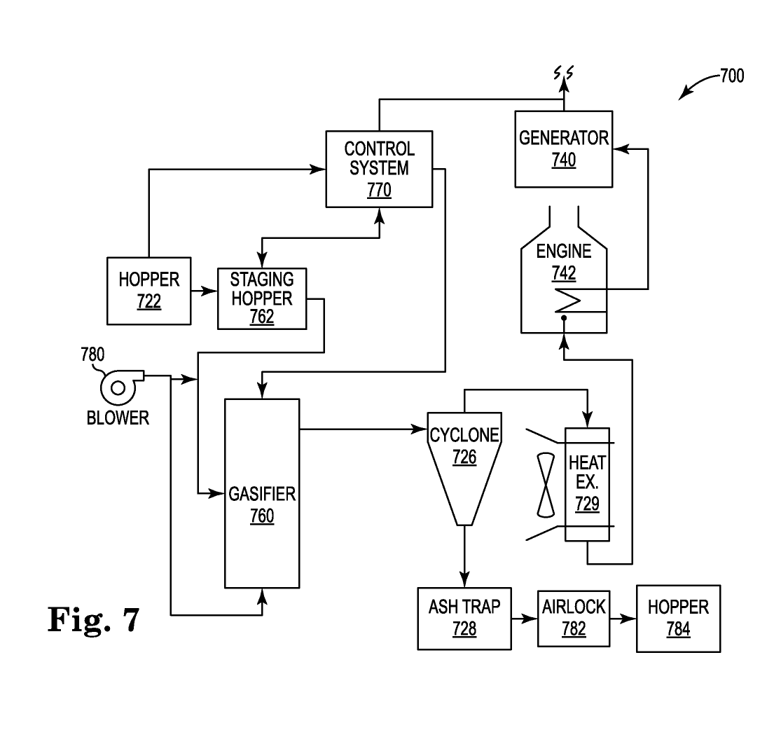

FIG. 7 is a block diagram of a gasification system 700 according to an embodiment of the invention. Gasification system 700, which may be a mobile gasification system (e.g. implemented within a mobile housing, such as a shipping container) may be implemented using gasification system 100 of FIG. 1. Gasification system 700 may include a hopper 722, a staging hopper 762, and a blower 780 that assists feed of the biomass feedstock from staging hopper 722 to gasifier 760 and feeds combustion air into gasifier 760. Hopper 722 may be used to implement the feedstock hopper and processor 104 of FIG. 1. Staging hopper 762 may be used to implement staging hopper 110 and/or staging hopper 210 of FIGS. 2-4, and may include electric motor 160, and/or level sensor 120 of FIG. 1. Blower 780 may be used to implement blower 180 of FIG. 1. Gasifier 760 may be used to implement gasifier 150 of FIG. 1. Gasifier 760 may provide syngas as an output to a cyclone 726. Cyclone 726 may separate biochar that became entrained in the syngas flow and provide the syngas to a heat exchanger 729. An ash trap 728 may receive the separated biochar from cyclone 726 and may collect the biochar in a hopper 784 via airlocks 782. In some embodiments, ash trap 728 may include a mechanism for cooling the biochar as the biochar is provided to airlocks 782, or prior to providing the biochar to airlocks 782. In some embodiments, a tar cracker may be placed between cyclone 726 and gasifier 760 to heat and destroy vaporized tars in the syngas. An example implementation of a tar cracker is described in application Ser. No. ______, entitled “APPARATUSES, SYSTEMS, TAR CRACKERS, AND METHODS FOR GASIFYING HAVING AT LEAST TWO MODES OF OPERATION,” which is hereby incorporated by reference in its entirety and for any purpose.

Heat exchanger 729 may extract heat from the syngas provided to it by cyclone 726. Heat exchanger 729 may provide the cooled syngas to an engine 742. Engine 742 may use the syngas as fuel to operate. Engine 742 may be coupled to a generator 740, and may drive generator 740 to provide electrical power. In other examples, the syngas may be used to generate electricity in other ways, and/or may be stored for later use.

During operation, gasification system 700 may gasify feedstock generated from residual biomass (e.g. straw, woody biomass, animal waste, grape pomace, or other agricultural waste). Staging hopper 762 may intermediate transport of the feedstock from hopper 722 to gasifier 760. Gasification system 700 may be a continuous flow system such that the feedstock is delivered from hopper 722 to gasifier 760 through staging hopper 762 in a continuous fashion to enable or promote an uninterrupted flow of feedstock within the combustion chamber of gasifier 760 for continual operation thereof. In some embodiments, blower 780 may assist feed of the biomass into gasifier 760 from staging hopper 762. Gasifier 760 may gasify the feedstock by reacting it with heat and combustion air. The combustion air may be introduced to gasifier 760 via blower 780. Blower 780 may be coupled to gasifier 760 such that airflow through gasifier 760 is controlled in two different ways. For example, blower 780 may be connected to gasifier 760 to push combustion air into gasifier 760, or to pull resultant gases from gasifier 760. In this manner, gasifier 760 may operate under vacuum (e.g., with blower 780 coupled between the output of gasifier 760 and the input of cyclone 726) or under pressure (e.g., with blower 780 coupled to an input of gasifier 760). Each method has its advantages. The use of a vacuum system removing the syngas from gasifier 760 may eliminate a potential for leakage of flammable gas to the atmosphere, as the entire system is at a negative pressure relative to the atmosphere. If a leak did develop, ambient air would be forced into gasifier 760, rather than flammable syngas leaking out.

The use of a pressure system to inject the combustion air into gasifier 760 may reduce a likelihood of fouling of blower 780, because the combustion air is relatively clean as compared to the syngas stream, which may include tars and other entrained particulates that can foul blower 780 and degrade its operation or cause it to malfunction. In some examples, gasification system 700 may be configurable to switch between pressure and vacuum operation based on desired operating conditions.

Gasifier 760 may include a preheater that preheats the combustion air and feedstock using hot syngas output from cyclone 726. Heating the combustion air and/or the feedstock may improve gasification efficiency. For example, heating the feedstock may reduce its moisture content prior to entering gasifier 760. Additionally, preheating the combustion air using the generated syngas may drive up system efficiency by reducing the time required for gasification temperatures within gasifier 760 to be reached.

Cyclone 726 may separate the biochar that has become entrained in the syngas flow to provide cleaned syngas to heat exchanger 729. Ash trap 728 may collect the biochar separated from the syngas by cyclone 726 and provide the collected biochar to hopper 784 via airlocks 782. Airlocks 782 may meter the amount of air that escapes during the transfer of the biochar to hopper 784.

Upon receiving cleaned syngas from cyclone 726, heat exchanger 729 may provide cooled syngas to engine 742. Engine 742 may use the provided syngas as fuel to operate. Engine 742 may be coupled to generator 740, and may drive generator 740 to provide electrical power. In some examples, engine 742 and/or generator 740 may be replaced with any combination of a storage tank, a furnace, a pump, or other device which may use or be driven by the syngas produced by gasifier 760 or through which stored syngas energy or syngas can be output (e.g. turbine, blower, etc.). Control system 770 may be used to control various components of gasification system 700 based on data collected from its components. Control system 770 may be used to implement controller 170 of FIG. 1. In some embodiments, control system 770 may measure a power output of generator 740 to determine whether too little or too much syngas is being produced, for example, to operate engine 742.

In some embodiments, control system 770 may control transfer of processed biomass from hopper 722 to staging hopper 762, and/or may control transfer rate of the processed feedstock from staging hopper 762 to gasifier 760. The control by control system 770 may include providing control signals to blowers, valves, and/or other components of gasification system 700, and may further include monitoring sensors, such as level sensors, temperature sensors, and/or energy production sensors.

The above description of illustrated embodiments of the invention is not intended to be exhaustive or to limit the invention to the precise form disclosed. While specific embodiments of, and examples of, the invention are described in the foregoing for illustrative purposes, various equivalent modifications are possible within the scope of the invention, as those skilled in the relevant art will realize. Moreover, the various embodiments described above can be combined to provide further embodiments. Accordingly, the invention is not limited by the disclosure, but instead the scope of the invention is to be determined entirely by the following claims.

What is claimed is:

1. A system comprising:
a staging hopper connected to a hopper, the staging hopper comprising a stirrer configured to continuously supply biomass feedstock to an outlet; and
a gasifier configured to receive the biomass feedstock from the outlet of the staging hopper and to gasify the biomass feedstock to provide syngas from a syngas outlet.

2. The system of claim 1, wherein the stirrer comprises a shaft extending through the floor of the staging hopper and sweep members affixed to the shaft above the floor of the staging hopper, the shaft configured to rotate the sweep members to flow the biomass feedstock to an outlet connected to the gasifier.

3. The system of claim 2, wherein the staging hopper further comprises an electric motor configured to rotate the shaft.

4. The system of claim 3, further comprising a controller configured to control a stir cycle frequency of the electric motor based on properties of the gasifier.

5. The system of claim 1, further comprising a transfer mechanism configured to transfer biomass feedstock from the hopper to the staging hopper responsive to a level of the staging hopper falling below a low threshold.

6. The system of claim 5, further comprising one or more sensors configured to indicate the level of biomass in the staging hopper.

7. The system of claim 5, wherein the staging hopper further comprises airlock valves that are configured to allow the gasifier to operate while the transfer mechanism is transferring the biomass feedstock from the hopper to the staging hopper.

8. The system of claim 5, wherein the transfer mechanism includes a blower configured to blow the biomass feedstock from the hopper to the staging hopper.

9. The system of claim 1, further comprising a blower configured to inject pressurized air into a conduit connecting an outlet of the staging hopper and to an inlet of the gasifier to assist flow of the feedstock from the staging hopper to the gasifier, wherein the blower is further configured to inject the pressurized air directly into a combustion air inlet of the gasifier.

10. A staging hopper comprising:
a side wall forming an enclosure;
a top portion connected to the side wall comprising a biomass feedstock inlet configured to receive biomass feedstock;
a floor connected to the side wall near a bottom edge of the side wall;
a shaft extending through the floor; and
sweep members affixed to the shaft at a spaced apart distance from the floor and configured to sweep the biomass feedstock toward an outlet as the shaft rotates.

11. The staging hopper of claim 10, further comprising:
a first valve configured to seal the inlet when providing the biomass feedstock via the outlet to a gasifier; and
a second valve configured to seal the outlet when receiving biomass feedstock via the inlet.

12. The staging hopper of claim 10, wherein the top portion further comprises a blower return configured to allow exhaust air to escape when receiving the biomass feedstock via the inlet.

13. The staging hopper of claim 15, further comprising a third valve configured to seal the blower return when providing the biomass feedstock via the outlet.

14. A method, comprising:
staging feedstock in a staging hopper of a gasification system; and
activating a stirrer to provide the feedstock from the staging hopper to a gasifier of the gasification system, wherein the gasifier is configured to gasify the feedstock to produce syngas.

15. The method of claim 14, wherein activating the stirrer to provide the feedstock from the staging hopper to the gasifier comprises rotating a stir rod to sweep the feedstock to an outlet of the staging hopper, wherein the outlet of the staging hopper is connected to an inlet of the gasifier.

16. The method of claim 14, wherein staging the feedstock in a staging hopper of a gasification system comprises adjusting airlocks to pressurize the staging hopper and the gasifier.

17. The method of claim 14, further comprising:
detecting a level in of the feedstock in the staging hopper; and
responsive to detecting the level of the feedstock is below a low threshold, activating a transfer mechanism to transfer additional feedstock to the staging hopper.

18. The method of claim 17, further comprising adjusting airlocks prior to activating the feedstock transfer mechanism to prevent depressurization of the gasifier.

19. The method of claim 18, wherein adjusting the airlocks prior to activating the feedstock transfer mechanism comprises:
opening a first knife gate valve; and
closing a second knife gate valve.

20. The method of claim 18, further comprising monitoring syngas production from a gasifier coupled to the staging hopper responsive to detecting that the staging hopper is above the low threshold.
